(19) United States
(12) Patent Application Publication
(10) Pub. No.: US 2017/0091630 A1
(43) Pub. Date: Mar. 30, 2017

(54) INFORMATION PROCESSING DEVICE, ANALYSIS METHOD, AND PROGRAM RECORDING MEDIUM

(71) Applicant: NEC CORPORATION, Tokyo (JP)

(72) Inventor: Shinichiro YOSHIDA, Tokyo (JP)

(73) Assignee: NEC CORPORATION, Tokyo (JP)

(21) Appl. No.: 15/126,779

(22) PCT Filed: Mar. 18, 2015
(86) PCT No.: PCT/JP2015/001497

§ 371 Date: Sep. 16, 2016

(30) Foreign Application Priority Data
Mar. 18, 2014 (JP) 2014-055286

(51) Int. Cl. G06N 5/04; G06F 11/34

(52) U.S. Cl. CPC G06N 5/04; G06F 11/3409; G06F 11/3447; G06F 2201/805; G06F 2201/81

(57) ABSTRACT

Allowable ranges of various characteristics in a system can be efficiently adjusted. An operation management apparatus (100) includes a correlation model storage unit (112) and an analysis unit (103). The correlation model storage unit (112) stores a correlation model which is based on a relation between different metrics among a plurality of metrics in a system. The analysis unit (103), when a new allowable range is set for one metric of the plurality of metrics, extracts and outputs, as a new allowable range for a metric for which an allowable range is to be changed, an allowable range satisfying a predicted variable range of the metric from a plurality of allowable ranges settable for the metric, based on the correlation model.

### TECHNICAL FIELD

The present invention relates to an information processing device, an analysis method, and a program recording medium.

### BACKGROUND ART

In an Information Technology (IT) system, a technique for controlling allowable ranges of a variety of characteristics of a system, such as allocation amounts of various resources, depending on a status of the system, is known.

For example, in an IT system, usage amounts of various resources are monitored, and when a usage amount of a resource exceeds a preset threshold value, an allocation amount of the resource is increased. As an example of such an IT system, PTL 1 discloses a computer system which dynamically increases a capacity or notifies of need for increasing a capacity when an exception to a threshold value with respect to a resource occurs.

Note that, as a related art, PTL 2 discloses an operation management apparatus which predicts, from one piece of performance information for a system, another piece of the performance information, based on a correlation model of the system.

### CITATION LIST

### Patent Literature

[PTL 1] Japanese Translation of PCT International Application Publication No. JP-T-2005-524886
[PTL 2] Japanese Patent No. 5141789

### SUMMARY OF INVENTION

### Technical Problem

In the technique disclosed in PTL 1, however, every time each resource in a system exceeds a threshold value, it is necessary to adjust an allocation amount of the resource. Thus, when the technique is applied to a large-scale computer system such as a cloud environment, it is necessary for an administrator or the like to adjust allocation amounts of a vast number of resources constituting the system every time each of the resources exceeds a threshold value. Consequently, this causes the system operation to be difficult.

An object of the present invention is to solve the above-described problem and provide an information processing device, an analysis method, and a program recording medium for efficiently adjusting allowable ranges of various characteristics in a system.

### Solution to Problem

An information processing device according to an exemplary aspect of the invention includes: a correlation model storage means for storing a correlation model which is based on a relation between different metrics among a plurality of metrics in a system; and an analysis means for, when a new allowable range is set for one metric of the plurality of metrics, extracting and outputting, as a new allowable range for a metric for which an allowable range is to be changed, an allowable range satisfying a predicted variable range of the metric from a plurality of allowable ranges settable for the metric, based on the correlation model.

An analysis method according to an exemplary aspect of the invention includes: storing a correlation model which is based on a relation between different metrics among a plurality of metrics in a system; and when a new allowable range is set for one metric of the plurality of metrics, extracting and outputting, as a new allowable range for a metric for which an allowable range is to be changed, an allowable range satisfying a predicted variable range of the metric from a plurality of allowable ranges settable for the metric, based on the correlation model.

A computer readable storage medium according to an exemplary aspect of the invention records thereon a program, causing a computer to perform a method including: storing a correlation model which is based on a relation between different metrics among a plurality of metrics in a system; and when a new allowable range is set for one metric of the plurality of metrics, extracting and outputting, as a new allowable range for a metric for which an allowable range is to be changed, an allowable range satisfying a predicted variable range of the metric from a plurality of allowable ranges settable for the metric, based on the correlation model.

### Advantageous Effects of Invention

An advantageous effect of the present invention is that allowable ranges of various characteristics in a system can be efficiently adjusted.

### BRIEF DESCRIPTION OF DRAWINGS

FIG. 1 is a block diagram illustrating a characteristic configuration of an exemplary embodiment of the present invention.

FIG. 2 is a block diagram illustrating a configuration of an operation management apparatus 100 according to the exemplary embodiment of the present invention.

FIG. 3 is a flowchart illustrating operation of the operation management apparatus 100 according to the exemplary embodiment of the present invention.

FIG. 4 is a diagram illustrating an example of a correlation model 122 according to the exemplary embodiment of the present invention.

FIG. 5 is a diagram illustrating an example of a correlation graph 132 according to the exemplary embodiment of the present invention.

FIG. 6 is a diagram illustrating an example of specification information 123 according to the exemplary embodiment of the present invention.

FIG. 7 is a diagram illustrating an example of an output screen 300 of an analysis result according to the exemplary embodiment of the present invention.

FIG. 8 is a diagram illustrating another example of the specification information 123 according to the exemplary embodiment of the present invention.

FIG. 9 is a diagram illustrating another example of the output screen 300 of an analysis result according to the exemplary embodiment of the present invention.

### DESCRIPTION OF EMBODIMENTS

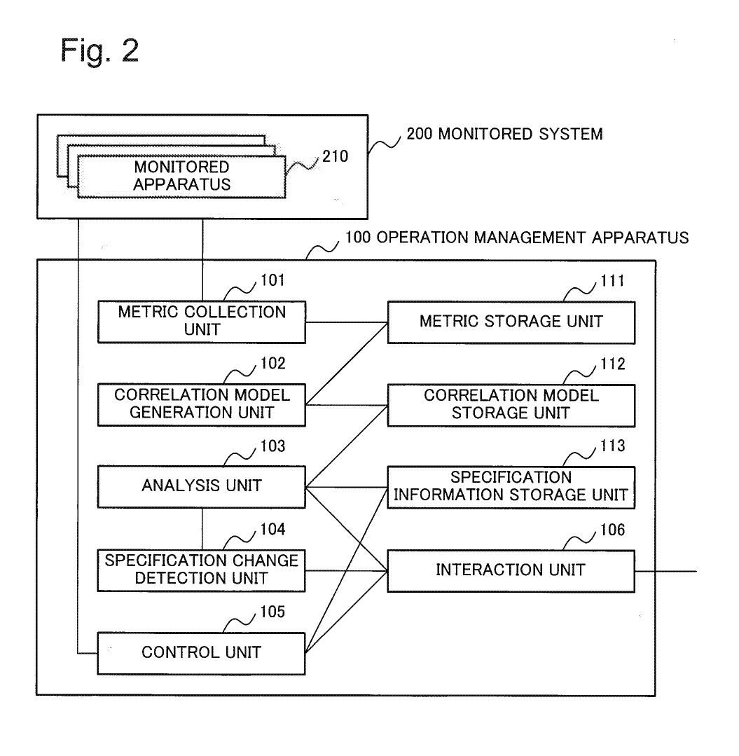

First, a configuration of an exemplary embodiment of the present invention is described. FIG. 2 is a block diagram illustrating a configuration of an operation management apparatus 100 according to the exemplary embodiment of the present invention. The operation management apparatus 100 is one exemplary embodiment of an information processing device of the present invention.

Referring to FIG. 2, the operation management apparatus 100 according to the exemplary embodiment of the present invention is connected to a monitored system 200.

The operation management apparatus 100 generates a correlation model 122 of the monitored system 200 based on actual measurement values of metrics which are indexes indicating various characteristics in the monitored system 200. The correlation model 122 represents a relation between different metrics among a plurality of metrics. A metric corresponds to an “element” for which a correlation model is generated in PTL 2. When an allowable range of a metric in the monitored system 200 is changed, the operation management apparatus 100 then calculates a variable range of another metric by using the generated correlation model 122.

In the exemplary embodiment of the present invention, it is assumed that the monitored system 200 is an IT system including one or more monitored apparatuses 210. The monitored apparatuses 210 are server apparatuses or network apparatuses constituting the monitored system 200.

In addition, in the exemplary embodiment of the present invention, a usage amount of each of various resources in each of the monitored apparatuses 210 is used as a metric. Herein, as a usage amount of a resource, a usage rate and a usage amount of a computer resource, such as a usage rate of a Central Processing Unit (CPU), a usage rate of a memory, and an access frequency of a disk, are used. In addition, as a usage amount of a resource, a usage rate and a usage amount of a network resource, such as a number of transfer packets in an input/output interface, may be used.

Hereinafter, an identifier of a metric is indicated by a pair of an apparatus identifier and a resource of the monitored apparatus 210. For example, a metric “SV1.CPU” indicates a usage rate of a CPU of the monitored apparatus 210 “SV1”. In addition, a metric “SV2.MEM” indicates a usage rate of a memory of the monitored apparatus 210 “SV2”.

In addition, in the exemplary embodiment of the present invention, a lower limit and an upper limit of an allowable range are set for each of metrics. An allowable range of a metric is set based on allowable ranges (a plurality of allowable ranges) respectively associated with a plurality of specifications settable for the metric.

For example, as an allowable range of the metric “SV1.CPU”, “0% to 100%” associated with a CPU specification “one” and “0% to 200%” associated with a CPU specification “two” of the monitored apparatus 210 “SV1” are used. In addition, as an allowable range of a metric “SV1.MEM”, “0 to 1000 MB” associated with a memory specification “1000 MB” and “0 to 2000 MB” associated with a memory specification “2000 MB” are used.

The monitored apparatus 210 measures an actual measurement value of a usage amount of each of resources at a certain interval, and transmits the actual measurement value to the operation management apparatus 100.

The operation management apparatus 100 includes a metric collection unit 101, a correlation model generation unit 102, an analysis unit 103, a specification change detection unit 104, a control unit 105, and an interaction unit 106. The operation management apparatus 100 further includes a metric storage unit 111, a correlation model storage unit 112, and a specification information storage unit 113.

The metric collection unit 101 collects the actual measurement value of each of metrics (the actual measurement value of a usage amount of each of resources) from the monitored apparatus 210.

The metric storage unit 111 stores a time series of the actual measurement values of each of the metrics collected by the metric collection unit 101.

The correlation model generation unit 102 generates a correlation model 122 of the monitored system 200 based on the time series of the actual measurement values of each of the metrics.

Herein, the correlation model 122 includes a correlation function (or a conversion function) indicating a correlation between each pair of metrics among a plurality of metrics. A correlation function is a function for predicting, from a value of one metric (input metric) among a pair of metrics, a value of the other metric (output metric). The correlation model generation unit 102 determines a coefficient of the correlation function for each pair of metrics based on a time series for a predetermined modeling period. The coefficient of the correlation function is determined by system identification process for a time series of actual measured values of a metric, in the same manner as the operation management apparatus in PTL 2. The correlation model generation unit 102 may calculate a weight for each pair of metrics based on a conversion error of the correlation function, in the same manner as the operation management apparatus in PTL 2.

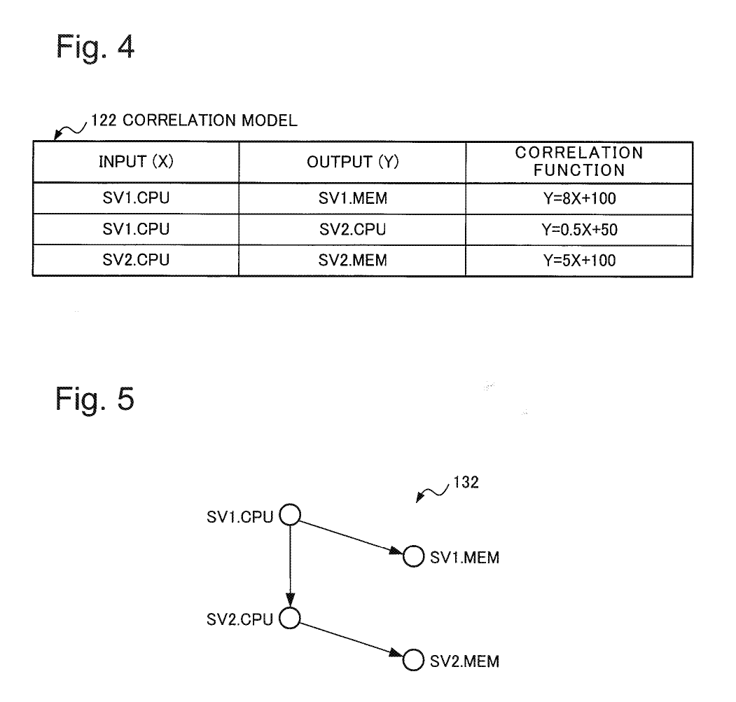

FIG. 4 is a diagram illustrating an example of the correlation model 122 according to the exemplary embodiment of the present invention. The correlation model 122 includes a correlation function for each pair of metrics.

Hereinafter, each correlation in the correlation model 122 is indicated by a pair of an identifier of an input metric and an identifier of an output metric. For example, a correlation “SV1.CPU-SV2.CPU” indicates a correlation between a metric “SV1.CPU” as an input and a metric “SV2.CPU” as an output.

FIG. 5 is a diagram illustrating an example of a correlation graph 132 according to the exemplary embodiment of the present invention. The correlation graph 132 in FIG. 5 corresponds to the correlation model 122 in FIG. 4. In the correlation graph 132, the correlation model 122 is expressed by a graph consisting of nodes (circles) and arrows. Herein, each node indicates a metric, and an arrow between metrics indicates a correlation. In addition, a metric at an origin of the arrow indicates an input metric, and a metric at a destination of the arrow indicates an output metric.

The correlation model storage unit 112 stores the correlation model 122 generated by the correlation model generation unit 102.

When a new specification (allowable range) is set for one metric (change source metric), the analysis unit 103 calculates, by using the generated correlation model 122, a variable range of another metric relating to a new allowable range of the change source metric. In addition, the analysis unit 103 compares the calculated variable range of the metric with a specification (allowable range) of the metric in specification information 123, and extracts a metric (change recommendation metric) for which a specification (allowable range) is to be changed.

The specification information storage unit 113 stores the specification information 123. The specification information 123 indicates a specification of each of the metrics in the monitored system 200.

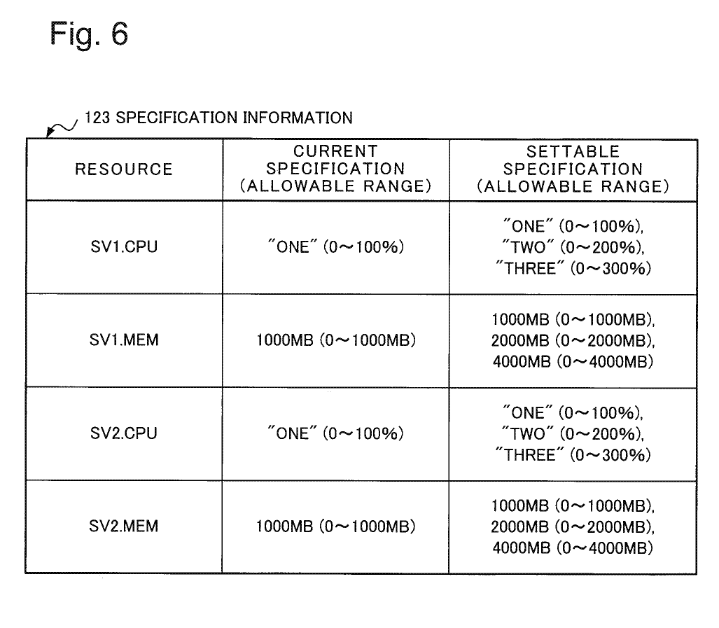

FIG. 6 is a diagram illustrating an example of the specification information 123 according to the exemplary embodiment of the present invention. In the example in FIG. 6, with an identifier of each of metrics, a “current specification” and “settable specifications” of the metric are associated. Herein, the “current specification” indicates a specification currently set for the metric. The “settable specifications” indicate specifications settable for the metric. Note that allowable ranges assigned to a current specification and settable specifications within parentheses, respectively, indicate allowable ranges of a metric for the current specification and the settable specifications.

The specification change detection unit 104 detects the change source metric in the monitored system 200.

The interaction unit 106 presents the change recommendation metric extracted by the analysis unit 103 to an administrator or the like.

The control unit 105 changes a specification of a metric in the monitored system 200.

Note that the operation management apparatus 100 may be a computer which includes a storage medium storing a CPU and a program and which operates under a control based on the program. In this case, the CPU of the operation management apparatus 100 executes the computer program for realizing functions of the metric collection unit 101, the correlation model generation unit 102, the analysis unit 103, the specification change detection unit 104, the control unit 105, and the interaction unit 106. In addition, the storage medium of the operation management apparatus 100 stores pieces of information on the metric storage unit 111, the correlation model storage unit 112, and the specification information storage unit 113. In addition, the metric storage unit 111, the correlation model storage unit 112, and the specification information storage unit 113 may be implemented by separate storage media or a single storage medium.

Next, the operation of the exemplary embodiment of the present invention is described.

Herein, it is assumed that specification information 123 as illustrated in FIG. 6 is stored in the specification information storage unit 113. In other words, “one” and “1000 MB” are respectively set for a CPU specification and a memory specification of the monitored apparatus 210 “SV1”. Likewise, “one” and “1000 MB” are respectively set for a CPU specification and a memory specification of the monitored apparatus 210 “SV2”.

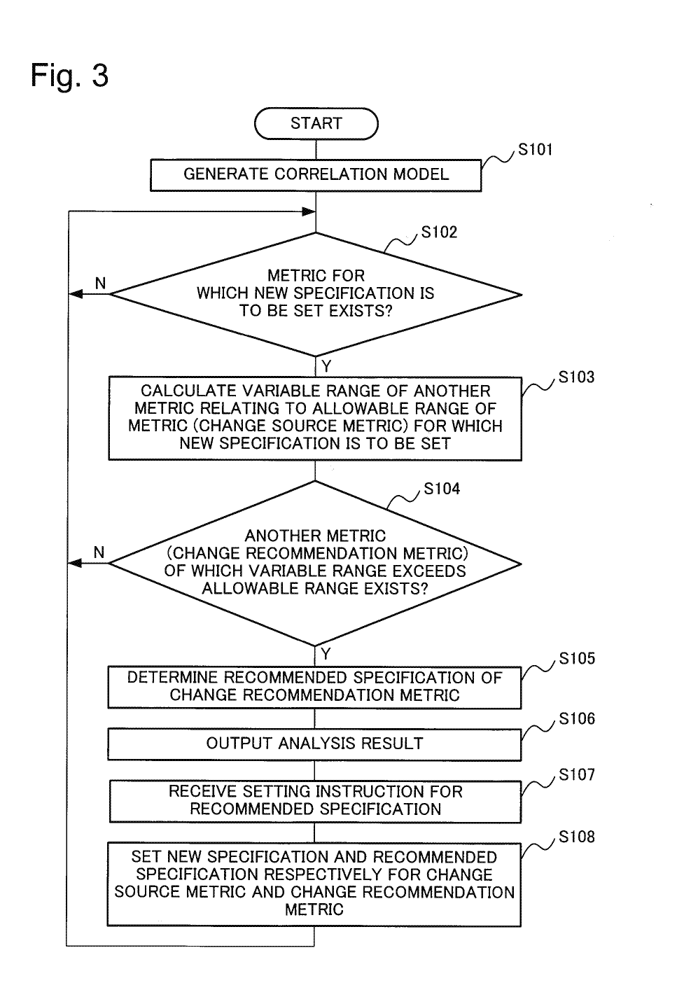

FIG. 3 is a flowchart illustrating the operation of the operation management apparatus 100 according to the exemplary embodiment of the present invention.

First, the correlation model generation unit 102 generates a correlation model 122 based on a time series of each of metrics stored in the metric storage unit 111 (Step S101). The correlation model generation unit 102 saves the generated correlation model 122 in the correlation model storage unit 112.

For example, the correlation model generation unit 102 stores the correlation model 122 as illustrated in FIG. 4 in the correlation model storage unit 112.

The specification change detection unit 104 detects, in the monitored system 200, a metric (change source metric) for which a new specification (allowable range) is to be set by a specification change (Step S102).

Herein, for example, when an actual measurement value of a metric exceeds a range of a predetermined threshold value (or falls within a range of a threshold value) for a current allowable range of the metric, a monitoring unit or the like (not illustrated) notifies an administrator or the like of the need for changing a specification of the metric. When receiving an input of a new specification of the metric from the administrator or the like, the specification change detection unit 104 detects the metric as a change source metric.

For example, when receiving an input of a new CPU specification “two” of the monitored apparatus 210 “SV1” from the administrator or the like since a usage rate of the CPU exceeds a threshold value “80%”, the specification change detection unit 104 detects “SV1.CPU” as a change source metric.

Note that, instead of receiving a new specification from the administrator or the like, the monitoring unit or the like may set a new specification associated with an allowable range which is larger (or smaller) than a current allowable range, for a metric of which an actual measurement value exceeds the range of the predetermined threshold value (or falls within the range of the threshold value). In this case, the specification change detection unit 104 detects the metric as a change source metric.

When there is a metric for which a new specification is to be set at Step S102 (Step S102/Y), the specification change detection unit 104 notifies the analysis unit 103 of an identifier and the new specification of the metric (change source metric).

The analysis unit 103 calculates a variable range of another metric relating to an allowable range associated with the new specification of the change source metric, while exploring correlation functions from the change source metric in the correlation model 122 (Step S103). Herein, the analysis unit 103 calculates a variable range of an output metric of a correlation function having the change source metric as an input. The variable range of the output metric of the correlation function is calculated using a value of the output metric of the correlation function when the input metric of the correlation function varies in the allowable range of the new specification. Furthermore, the analysis unit 103 calculates a variable range of an output metric of another correlation function having the metric for which the variable range has been calculated as an input. The variable range of the output metric of the correlation function is calculated using a value of the output metric of the correlation function when a value of the input metric of the correlation function varies in the calculated variable range. The analysis unit 103 then repeats the calculation of a variable range of an output metric of another correlation function having a metric for which a variable range has been calculated as an input until there is no other correlation function having the metric for which the variable range has been calculated as an input.

For example, an allowable range associated with the new CPU specification “two” of the monitored apparatus 210 “SV1” is “0 to 200%”. The analysis unit 103 calculates a variable range “0 to 1700 MB” of a metric “SV1.MEM” relating to the allowable range “0 to 200%” of a metric “SV1.CPU” by using a correlation function for a correlation “SV1.CPU-SV1.MEM” in the correlation model 122 in FIG. 4. In addition, the analysis unit 103 calculates a variable range “0 to 150%” of a metric “SV2.CPU” relating to the allowable range “0 to 200%” of the metric “SV1.CPU” by using a correlation function for a correlation “SV1.CPU-SV2.CPU”. Furthermore, the analysis unit 103 calculates a variable range “0 to 850 MB” of a metric “SV2.MEM” relating to the variable range “0 to 150%” of the metric “SV2.CPU” by using a correlation function for a correlation “SV2.CPU-SV2.MEM”.

In this manner, the analysis unit 103 calculates, for another metric being predictable from a change source metric by using a correlation function or a combination of correlation functions in the correlation model 122, a variable range of the metric relating to an allowable range of the change source metric.

Note that when there are a plurality of different correlation functions or a plurality of different combinations of correlation functions from a change source metric to another predictable metric, a correlation function or a combination of correlation functions may be selected based on a weight of each of the correlation functions, in the same manner in PTL 2.

The analysis unit 103 extracts a metric of which the calculated variable range exceeds an allowable range associated with the currently set specification, from the metrics for which the variable ranges are calculated at Step S103 (Step S104).

When there is a metric exceeding an allowable range at Step S104 (Step S104/Y), the analysis unit 103 determines the metric as a metric (change recommendation metric) for which a specification needs to be changed. The analysis unit 103 then determines a specification (recommended specification) recommended for the change recommendation metric (Step S105). Herein, the analysis unit 103 extracts, for example, from allowable ranges respectively associated with specifications settable for the change recommendation metric, a minimum allowable range which is not exceeded by a variable range of the change recommendation metric, and determines a specification associated with the extracted allowable range as a recommended specification.

For example, the variable range “0 to 1700 MB” of the metric “SV1.MEM” exceeds the allowable range “0 to 1000 MB” associated with the current memory specification “1000 MB” of the monitored apparatus 210 “SV1”. Accordingly, the analysis unit 103 determines the metric “SV1.MEM” as a change recommendation metric, and determines a recommended specification of the metric to a specification “2000 MB” associated with an allowable range “0 to 2000 MB”.

In addition, the variable range “0 to 150%” of the metric “SV2.CPU” exceeds the allowable range “0 to 100%” associated with the current CPU specification “one” of the monitored apparatus 210 “SV2”. Accordingly, the analysis unit 103 determines the metric “SV2.CPU” as a change recommendation metric, and determines a recommended specification of the metric to a specification “two” associated with an allowable range “0 to 200%”.

The analysis unit 103 outputs the recommended specification of the change recommendation metric calculated at Step S105 to the administrator or the like as an analysis result (Step S106). Herein, the analysis unit 103 displays, via the interaction unit 106, the analysis result on, for example, a display device (not illustrated) such as a display.

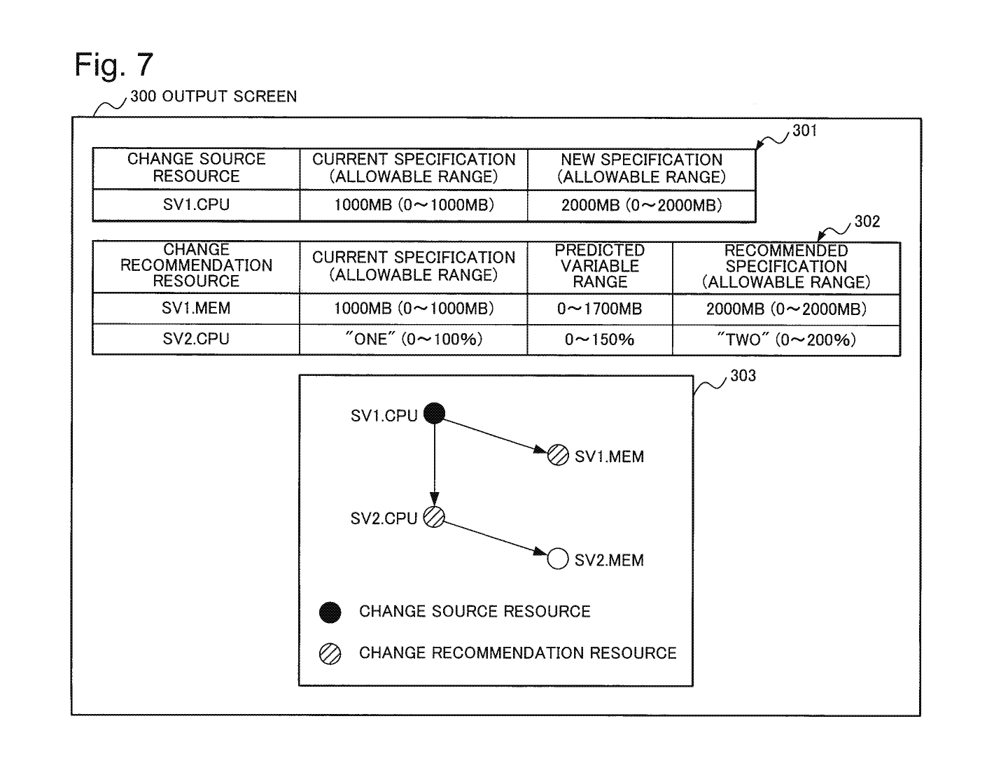

FIG. 7 is a diagram illustrating an example of an output screen 300 of an analysis result according to the exemplary embodiment of the present invention.

In the example in FIG. 7, the output screen 300 includes change source information 301, change recommendation information 302, and a correlation graph 303.

The change source information 301 indicates information with respect to a change source metric. The change source information 301 includes a “change source resource”, a “current specification”, and a “new specification”. Herein, the “change source resource” indicates an identifier of a change source metric. The “current specification” indicates a currently set specification for the change source metric. The “new specification” indicates a new specification of the change source metric.

The change recommendation information 302 indicates information with respect to a change recommendation metric. The change recommendation information 302 includes a “change recommendation resource”, a “current specification”, a “predicted variable range”, and a “recommended specification”. Herein, the “change recommendation resource” indicates an identifier of a change recommendation metric. The “current specification” indicates a currently set specification for the change recommendation metric. The “predicted variable range” indicates a variable range calculated for the change recommendation metric. The “recommended specification” indicates a recommended specification extracted for the change recommendation metric.

The correlation graph 303 illustrates a graph representing the correlation model 122. In the correlation graph 303, a change source metric and change recommendation metrics are highlighted.

For example, the analysis unit 103 outputs the output screen 300 as illustrated in FIG. 7 via the interaction unit 106.

Note that the analysis unit 103 may present, on the output screen 300, variable ranges calculated for all metrics predictable from a change source metric by using a correlation function or a combination of correlation functions, without limitation to a variable range calculated for a change recommendation metric.

The control unit 105 receives an input of a setting instruction for the recommended specification of the change recommendation metric from the administrator or the like via the interaction unit 106 (Step S107).

The control unit 105 sets the new specification and the recommended specification respectively for the change source metric and the change recommendation metric in the monitored system 200 (Step S108).

For example, the control unit 105 instructs the monitored system 200 to allocate two CPUs and a memory of 2000 MB of the monitored apparatus 210 “SV1”, and two CPUs of the monitored apparatus 210 “SV2”.

Note that the analysis unit 103 may set, instead of setting the recommended specification for the change recommendation metric, a new specification input from the administrator or the like for the change recommendation metric.

In addition, the analysis unit 103 may set, without presenting the analysis result to the administrator or the like and receiving the setting instruction from the administrator or the like, the new specification and the recommended specification for the change source metric and the change recommendation metric.

The control unit 105 updates the specification information 123 in accordance with the new specification and the recommended specification, and stores the updated specification information 123 in the specification information storage unit 113.

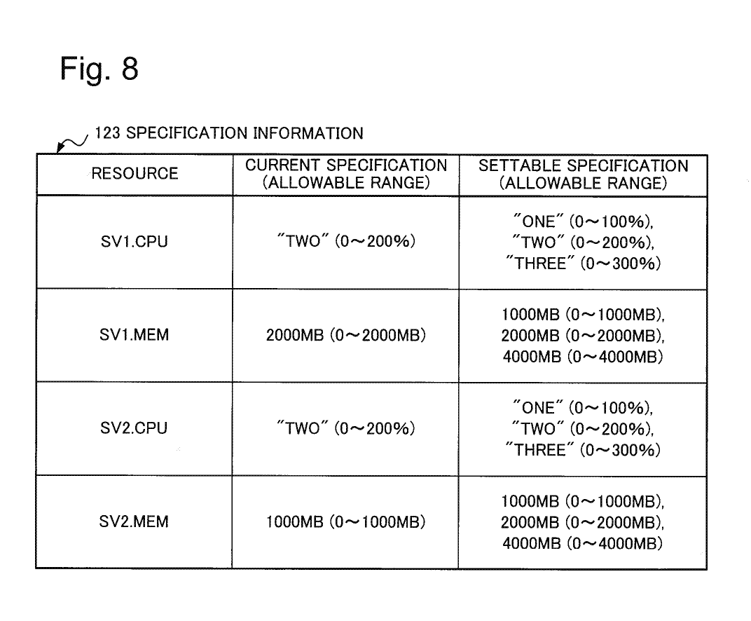

FIG. 8 is a diagram illustrating another example of the specification information 123 according to the exemplary embodiment of the present invention.

For example, the control unit 105 updates the specification information 123 as illustrated in FIG. 8.

Thereafter, processing from Step S102 is repeated.

Note that at Step S104 described above, the analysis unit 103 may further extract, as a change recommendation metric, a metric for which another allowable range, which is not exceeded by the variable range and smaller than a currently set allowable range, is settable.

For example, it is assumed that when the specification information 123 as illustrated in FIG. 8 is stored in the specification information storage unit 113, a new CPU specification “one” of the monitored apparatus 210 “SV1” is input from the administrator or the like.

In this case, an allowable range associated with the new CPU specification “one” of the monitored apparatus 210 “SV1” is “0 to 100%”. The analysis unit 103 calculates a variable range “0 to 900 MB” of the metric “SV1.MEM” relating to the allowable range “0 to 100%” of the metric “SV1.CPU” by using the correlation function for the correlation “SV1.CPU-SV1.MEM” in the correlation model 122 in FIG. 4. In addition, the analysis unit 103 calculates a variable range “0 to 100%” of the metric “SV2.CPU” relating to the allowable range “0 to 100%” of the metric “SV1.CPU” by using the correlation function for the correlation “SV1.CPU-SV2.CPU”. Furthermore, the analysis unit 103 calculates a variable range “0 to 650 MB” of the metric “SV2.MEM” relating to the variable range “0 to 100%” of the metric “SV2.CPU” by using a correlation function for the correlation “SV2.CPU-SV2.MEM”.

The variable range “0 to 900 MB” of the metric “SV1.MEM” does not exceed the allowable range “0 to 1000 MB” associated with the specification “1000 MB” settable for the memory of the monitored apparatus 210 “SV1”. Accordingly, the analysis unit 103 determines the metric “SV1.MEM” as a change recommendation metric, and determines a recommended specification of the metric to “1000 MB”.

In addition, the variable range “0 to 100%” of the metric “SV2.CPU” does not exceed the allowable range “0 to 100%” associated with the specification “one” settable for the CPU of the monitored apparatus 210 “SV2”. Accordingly, the analysis unit 103 determines the metric “SV2.CPU” as a change recommendation metric, and determines a recommended specification of the metric to “one”.

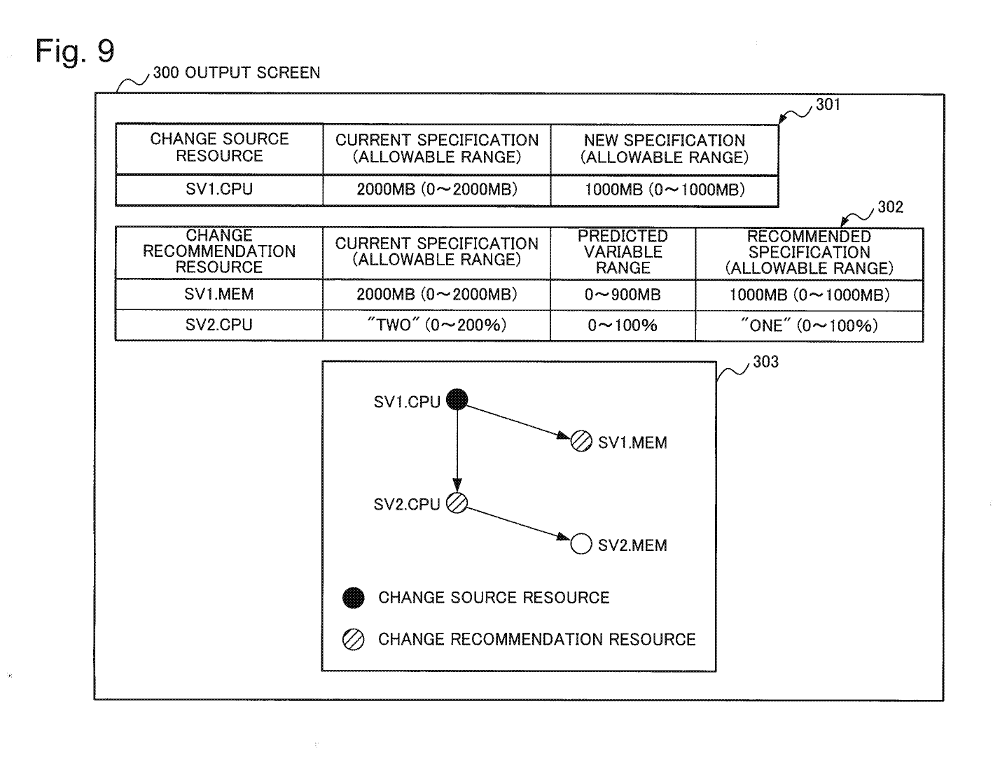

FIG. 9 is a diagram illustrating another example of the output screen 300 of an analysis result according to the exemplary embodiment of the present invention.

The analysis unit 103 outputs the output screen 300 as illustrated in FIG. 9 via the interaction unit 106.

The operation according to the exemplary embodiment of the present invention is thus completed.

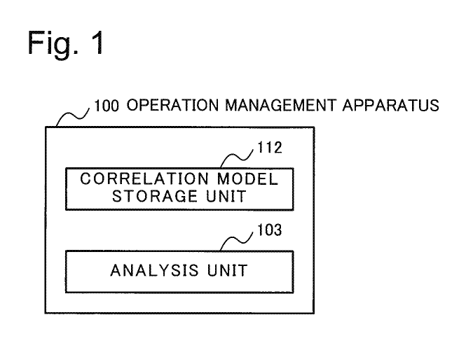

Next, a characteristic configuration of the exemplary embodiment of the present invention will be described. FIG. 1 is a block diagram illustrating a characteristic configuration of the exemplary embodiment of the present invention.

Referring to FIG. 1, an operation management apparatus 100 (information processing device) according to the exemplary embodiment of the present invention includes a correlation model storage unit 112 and an analysis unit 103.

The correlation model storage unit 112 stores a correlation model which is based on a relation between different metrics among a plurality of metrics in a system. The analysis unit 103, when a new allowable range is set for one metric of the plurality of metrics, extracts and outputs a new allowable range for a metric for which an allowable range is to be changed from a plurality of allowable ranges settable for the metric. Here, the analysis unit 103 extracts, as the new allowable range for the metric, an allowable range satisfying a predicted variable range of the metric from a plurality of allowable ranges settable for the metric based on the correlation model.

According to the exemplary embodiment of the present invention, allowable ranges of various characteristics in a system can be efficiently adjusted. The reason is that the analysis unit 103 extracts and outputs, as a new allowable range for a metric for which an allowable range is to be changed, an allowable range satisfying a predicted variable range of the metric from a plurality of allowable ranges settable for the metric, based on a correlation model.

With this, when an allowable range for one metric is changed, a metric for which an allowable range is to be changed and a new allowable range for the metric can be presented together. Accordingly, when changing an allowable range for one metric, an administrator or the like can adjust allowable ranges for other metrics collectively, eliminating the need for adjusting allowable ranges every time each of metrics exceeds a threshold value. Thus, an administrator or the like can adjust an allowable range for each of metrics even in a large-scale system.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, in the exemplary embodiment of the present invention, a usage amount of each of various resources in an IT system is used as a metric. However, any index indicating each of various characteristics in a system may be used as a metric other than resources in the IT system. For example, a metric may be a physical amount such as a temperature in each of steps of a plant, and a carrying capacity in each of steps of a distribution system.

This application is based upon and claims the benefit of priority from Japanese Patent Application No. 2014-055286, filed on Mar. 18, 2014, the disclosure of which is incorporated herein in its entirety by reference.

### REFERENCE SIGNS LIST

100 Operation management apparatus
101 Metric collection unit
102 Correlation model generation unit
103 Analysis unit
104 Specification change detection unit
105 Control unit
106 Interaction unit
111 Metric storage unit
112 Correlation model storage unit
113 Specification information storage unit
122 Correlation model
123 Specification information
132 Correlation graph
200 Monitored system
210 Monitored apparatus
300 Output screen
301 Change source information
302 Change recommendation information
303 Correlation graph

1. An information processing device comprising:
a correlation model storage unit which stores a correlation model which is based on a relation between different metrics among a plurality of metrics in a system; and
an analysis unit which, when a new allowable range is set for one metric of the plurality of metrics, extracts and outputs, as a new allowable range for a metric for which an allowable range is to be changed, an allowable range satisfying a predicted variable range of the metric from a plurality of allowable ranges settable for the metric, based on the correlation model.

2. The information processing device according to claim 1, wherein
the analysis unit extracts a metric of which the predicted variable range exceeds an allowable range being currently set, as the metric for which the allowable range is to be changed, from one or more other metrics among the plurality of metrics.

3. The information processing device according to claim 1, wherein
the analysis unit extracts a metric for which another allowable range is settable, the another allowable range being not exceeded by the predicted variable range and smaller than an allowable range being currently set, as the metric for which the allowable range is to be changed, from one or more other metrics among the plurality of metrics.

4. The information processing device according to claim 1, further comprising a control unit which sets the new allowable range for the one metric and the new allowable range for the metric for which the allowable range is to be changed, in the system.

5. The information processing device according to claim 1, wherein
the correlation model includes one or more correlation functions between different metrics among the plurality of metrics, and
the analysis unit predicts the variable range by calculating, for each of one or more other metrics predictable from the one metric by using the correlation function or a combination of the correlation functions among the plurality of metrics, a value of the other metric relating to the new allowable range of the one metric, based on the correlation model.

6. The information processing device according to claim 5, wherein
the analysis unit indicates the one metric and the metric for which the allowable range is to be changed, on a graph representing a correlation between the one metric and the one or more other metrics.

7. An analysis method comprising:
extracting, when a new allowable range is set for one metric of a plurality of metrics in a system, as a new allowable range for a metric for which an allowable range is to be changed, an allowable range satisfying a predicted variable range of the metric from a plurality of allowable ranges settable for the metric, based on a correlation model which is based on a relation between different metrics among the plurality of metrics, and
outputting the extracted allowable range.

8. The analysis method according to claim 7, wherein
a metric of which the predicted variable range exceeds an allowable range being currently set is extracted, as the metric for which the allowable range is to be changed, from one or more other metrics among the plurality of metrics.

9. The analysis method according to claim 7, wherein
a metric for which another allowable range is settable is extracted, the another allowable range being not exceeded by the predicted variable range and smaller than an allowable range being currently set, as the metric for which the allowable range is to be changed, from one or more other metrics among the plurality of metrics.

10. The analysis method according to claim 7, further comprising setting the new allowable range for the one metric and the new allowable range for the metric for which the allowable range is to be changed, in the system.

11. The analysis method according to claim 7, wherein
the correlation model includes one or more correlation functions between different metrics among the plurality of metrics, and
the variable range is predicted by calculating, for each of one or more other metrics predictable from the one metric by using the correlation function or a combination of the correlation functions among the plurality of metrics, a value of the other metric relating to the new allowable range of the one metric, based on the correlation model.

12. The analysis method according to claim 11, further comprising indicating the one metric and the metric for which the allowable range is to be changed, on a graph representing a correlation between the one metric and the one or more other metrics.

13. A non-transitory computer readable storage medium recording thereon a program, causing a computer to perform a method comprising:
extracting, when a new allowable range is set for one metric of a plurality of metrics, as a new allowable range for a metric for which an allowable range is to be changed, an allowable range satisfying a predicted variable range of the metric from a plurality of allowable ranges settable for the metric, based on a correlation model which is based on a relation between different metrics among the plurality of metrics in a system, and
outputting the extracted allowable range.

14. The non-transitory computer readable storage medium recording thereon the program according to claim 13, wherein
a metric of which the predicted variable range exceeds an allowable range being currently set is extracted, as the metric for which the allowable range is to be changed, from one or more other metrics among the plurality of metrics.

15. The non-transitory computer readable storage medium recording thereon the program according to claim 13, wherein
a metric for which another allowable range is settable is extracted, the another allowable range being not exceeded by the predicted variable range and smaller than an allowable range being currently set, as the metric for which the allowable range is to be changed, from one or more other metrics among the plurality of metrics.

16. The non-transitory computer readable storage medium recording thereon the program according to claim 13, further comprising setting the new allowable range for the one metric and the new allowable range for the metric for which the allowable range is to be changed, in the system.

17. The non-transitory computer readable storage medium recording thereon the program according to claim 13, wherein
the correlation model includes one or more correlation functions between different metrics among the plurality of metrics, and
the variable range is predicted by calculating, for each of one or more other metrics predictable from the one metric by using the correlation function or a combination of the correlation functions among the plurality of metrics, a value of the other metric relating to the new allowable range of the one metric, based on the correlation model.

18. The non-transitory computer readable storage medium recording thereon the program according to claim 17, further comprising indicating the one metric and the metric for which the allowable range is to be changed, on a graph representing a correlation between the one metric and the one or more other metrics.

19. An information processing device comprising:
a correlation model storage means for storing a correlation model which is based on a relation between different metrics among a plurality of metrics in a system; and
an analysis means for, when a new allowable range is set for one metric of the plurality of metrics, extracting and outputting, as a new allowable range for a metric for which an allowable range is to be changed, an allowable range satisfying a predicted variable range of the metric from a plurality of allowable ranges settable for the metric, based on the correlation model.
